(19) United States
(12) Patent Application Publication
(10) Pub. No.: US 2011/0069341 A1
(43) Pub. Date: Mar. 24, 2011

(54) PRINT CONTROL DEVICE AND CONTROLLING METHOD THEREOF

(75) Inventors: Young-ju KIM, Suwon-si (KR); Sang-hyup Lee, Suwon-si (KR)

(73) Assignee: Samsung Electronics Co., Ltd, Suwon-si (KR)

(21) Appl. No.: 12/787,513

(22) Filed: May 26, 2010

(30) Foreign Application Priority Data
Sep. 24, 2009 (KR) 2009-90592

(51) Int. Cl. G06F 15/00

(52) U.S. Cl. 358/1.15

(57) ABSTRACT

A method to control a print control device having a universal printer driver is provided. The present method comprises searching a plurality of image forming apparatuses, displaying the first list including the searched image forming apparatuses, if the first image forming apparatus is selected from the first list, displaying a driver user interface (UI) corresponding to the selected first image forming apparatus, displaying the second list including at least one image forming apparatus while the driver UI is maintained, and if the second image forming apparatus is selected from the second list, displaying a driver UI corresponding to the selected second image forming apparatus. Accordingly, a user may use the universal printer driver more conveniently.

### CROSS-REFERENCE TO RELATED APPLICATIONS

This application claims priority under 35 U.S.C. §119(a) from Korean Patent Application No. 2009-90592, filed on Sep. 24, 2009, in the Korean Intellectual Property Office, the contents of which are incorporated herein by reference in their entirety.

### BACKGROUND

1. Field of the Invention

The present general inventive concept relates to a print control device and a controlling method, and more particularly, to a print control device which is connectable to a plurality of image forming apparatuses using a universal printer driver and a controlling method thereof.

2. Description of the Related Art

With the development of electronic technology, various computer peripheral devices have been developed and distributed, and one of those devices is an image forming apparatus. Specifically, a printer, a scanner, or a multi-functional printer is being used as an image forming apparatus.

A user may print a desired document using a print control device such as his or her computer and an image forming apparatus connected to the print control device. In this case, in order for the print control device to control the print function of the image forming apparatus, a print driver provided by the manufacturer of the image forming apparatus should be installed.

A print driver provides a user interface to set a print option which is applied to a document to be printed. The user interface provided by a print driver will be referred to in the present specification as a driver UI.

A user may set various print options for a document to be printed using the driver UI. The example of the print options includes paper size, paper type, feeding tray selection, double-sided printing, stapler, offset, overlay, watermark, and page make-up. The user may set a print option by selecting and combining a plurality of print options, or may register a frequently used print option as a preferred print option.

Recently, not only an image forming apparatus which is locally connected to a user terminal device but also an image forming apparatus which is connected through a network is widely used. That is, there could be a plurality of image forming apparatuses that can be used in a single print control device. In this case, a print driver corresponding to each image forming apparatus may be installed in a print control device, or a single universal printer driver may be installed in a print control device and then used. The universal printer driver is a program to control print functions of a plurality of image forming apparatuses.

However, the universal printer driver provides different driver UIs for each image forming apparatus. Accordingly, in order to change a currently displayed driver UI to another driver UI, the currently displayed driver UI should be closed, another available image forming apparatus should be searched again, the searched image forming apparatus should be selected, and then the driver UI of the new image forming apparatus should be displayed.

In particular, if the image forming apparatus selected by a user does not support a print option desired by the user, the user should use the driver UI of another image forming apparatus and this may cause great inconvenience to the user.

### SUMMARY

The present general inventive concept provides a print control device which controls the operation of a plurality of image forming apparatuses using a universal printer driver, thereby enhancing user convenience and a controlling method thereof.

Additional features and utilities of the present general inventive concept will be set forth in part in the description which follows and, in part, will be obvious from the description, or may be learned by practice of the general inventive concept.

A method of controlling a print control device having a universal printer driver capable of controlling a plurality of image forming apparatuses includes searching the plurality of image forming apparatuses to print a document to be printed, displaying a first list including at least one image forming apparatus according to the search result, displaying, if a first image forming apparatus is selected from the first list, a driver user interface (UI) corresponding to the selected first image forming apparatus, displaying a second list including at least one image forming apparatus while the driver UI is maintained, and displaying, if a second image forming apparatus is selected from the second list, a driver UI corresponding to the selected second image forming apparatus.

The method may further include generating a print data for a document to be printed using a driver UI of the second image forming apparatus and transmitting the generated print data to the second image forming apparatus.

The second list may include a first image forming apparatus corresponding to a currently displayed driver UI.

The operation of displaying the second list may include composing the second list according to at least one of pre-stored information in the print control device and search result information of newly connected image forming apparatus.

The method may further include confirming, if the second image forming apparatus is selected from the second list, whether the selected second image forming apparatus is currently operated.

The second list may be selected by a user or an administrator.

The second list may be included in the driver UI or may be displayed in a separate pop-up window.

The second list may display at least one of information regarding at least one image forming apparatus and its setting.

The method may further include storing at least one of information regarding a first image forming apparatus selected from the first list and a second image forming apparatus selected from the second list as historical information.

The operation of displaying the second list may include displaying an image forming apparatus included in the stored historical information distinctively from other image forming apparatuses in the second list, or in a separate application UI.

The method may further include storing the first list.

Features and/or utilities of the present general inventive concept may also be realized by a print control device having a universal printer driver capable of controlling a plurality of image forming apparatuses including an interface unit connectable to a plurality of image forming apparatuses, a search unit to search the plurality of image forming apparatuses, a user interface unit to display a first list for the searched image forming apparatus, a UI generation unit, if a first image forming apparatus is selected from the first list, to generate a driver UI corresponding to the selected first image forming apparatus and display it through the user interface unit, and a control unit to display a second list including at least one image forming apparatus while the driver UI is maintained and, if a second image forming apparatus is selected from the second list, control the UI generation unit to generate a driver UI corresponding to the selected second image forming apparatus.

The print control device may further include a first storage unit to store the universal printer driver, and the control unit may drive the search unit and the UI generation unit by executing the universal printer driver, may generate a print data for a document to be printed using a driver UI of the second image forming apparatus, and may transmit the generated print data to the second image forming apparatus.

The control unit, if the second image forming apparatus is selected from the second list, may identify a current state of the selected second image forming apparatus and display a driver UI or an alert message corresponding to the second image forming apparatus according to the identified information.

The second list may be included in the driver UI or be displayed in a separate pop-up window.

The second list may display information regarding at least one image forming apparatus and its setting.

The print control device may further include a second storage unit to store at least one of information regarding a first image forming apparatus selected from the fist list and a second image forming apparatus selected from the second list as historical information.

The control unit may control the user interface unit to display an image forming apparatus included in the stored historical information distinctively from other image forming apparatuses in the second list, or in a separate application UI.

According to various exemplary embodiments of the present general inventive concept, a user may use a universal printer driver more conveniently and thus perform printing in an appropriate image forming apparatus.

Features and/or utilities of the present general inventive concept may also be realized by a method of selecting an image-forming apparatus including executing a universal image forming apparatus driver on an image-forming apparatus control device to display a user interface including a plurality of image-forming apparatuses connected to the image-forming apparatus control device, each displayed image-forming apparatus corresponding to a separate driver.

The method may include receiving a selection corresponding to a first image-forming apparatus of the plurality of image-forming apparatuses to form an image on the first image-forming apparatus.

The method may include forming the image on the first image-forming apparatus without opening the separate driver of the first image-forming apparatus.

The method may include executing a first driver corresponding to the first image-forming apparatus to form the image on the first image-forming apparatus.

Executing the first driver corresponding to the first image-forming apparatus may include displaying a printer configuration user interface of the first image-forming apparatus.

The method may include receiving a selection corresponding to a second image-forming apparatus of the plurality of image-forming apparatuses, and simultaneously with executing the first driver, executing a second driver different from the first driver, the second driver corresponding to the second image-forming apparatus to form an image on the second image-forming apparatus.

The universal driver may be executed in response to a print command on the image-forming apparatus control device.

Executing the universal image forming apparatus driver may include displaying a model corresponding to each of the plurality of image-forming apparatuses.

Executing the universal image forming apparatus driver may include displaying an image-forming function of each of the plurality of image-forming apparatuses.

The method may include querying the plurality of image-forming apparatuses connected to the image-forming apparatus control device to generate the plurality of image-forming apparatuses to display on the user interface.

Features and/or utilities of the present general inventive concept may also be realized by a print control device including an image-forming apparatus interface to connect to a plurality of image-forming apparatuses, each image-forming apparatus corresponding to a separate driver, a data storage unit to store a universal image-forming apparatus driver, and a controller to execute the universal image-forming apparatus driver to form an image on each of the plurality of image-forming apparatuses.

The print control device may include a graphical user interface generation unit to generate a graphical user interface that displays each of the plurality of image-forming apparatuses.

The print control device may include a display, and the graphical user interface may be displayed on the display.

The graphical user interface generation unit may generate the graphical user interface using only the universal image-forming apparatus driver.

The graphical user interface generation unit may generate the graphical user interface using separate drivers corresponding to each of the plurality of image-forming apparatuses, respectively.

The print control device may include a user interface unit to receive a user input to select at least one of the plurality of image-forming devices to form an image.

The controller may execute a separate driver corresponding to each of the plurality of image-forming apparatuses when each of the plurality of image-forming apparatuses is selected to perform an imaging operation.

The controller may control the plurality of image-forming apparatuses to perform respective image-forming operations using only the universal image-forming apparatus driver.

Features and/or utilities of the present general inventive concept may also be realized by a computer-readable medium having stored thereon a universal image-forming apparatus driver to control an image-forming apparatus control device to perform a method including displaying a user interface including a plurality of image-forming apparatuses connected to the image-forming apparatus control device, each displayed image-forming apparatus corresponding to a separate driver, and performing an image-forming operation on at least one of the plurality of image-forming apparatuses using the universal image-forming apparatus driver.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a view illustrating the structure of a print system according to an exemplary embodiment of the present general inventive concept;

FIG. 2 is a block diagram illustrating the structure of a print control device according to an exemplary embodiment of the present general inventive concept;

FIG. 3 to FIG. 7 are views illustrating various screen configuration of a print control device according to an exemplary embodiment of the present general inventive concept;

FIG. 8 is a block diagram illustrating an example of the detailed structure of a print control device according to an exemplary embodiment of the present general inventive concept;

FIG. 9 is a flow chart provided to explain a method to control a print control device according to an exemplary embodiment of the present general inventive concept;

FIG. 10 is a flow chart provided to explain a method to control a print control device in detail according to an exemplary embodiment of the present general inventive concept;

FIG. 11 illustrates a user interface screen according to an embodiment of the present general inventive concept; and

FIG. 12 illustrates a user interface screen according to an embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures. Throughout the specification and claims, the terms “first” and “second” are used only to distinguish different elements and may be used interchangeably with different elements depending on the context.

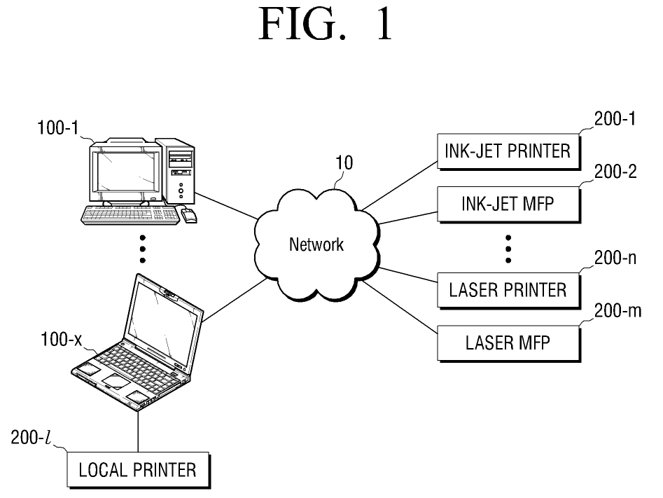

FIG. 1 is a view illustrating the structure of a print system according to an exemplary embodiment of the present general inventive concept. Referring to FIG. 1, the print system may include a plurality of print control devices 100-1, . . . , 100-x and a plurality of image forming apparatuses 200-1, 200-2, . . . , 200-l, 200-m, 200-n which are connected through a network 10.

In FIG. 1, a desktop PC 100-1, a lap-top computer 100-x, and so forth are illustrated as the print control device 100-1, . . . , 100-x, but other electronic devices such as a mobile phone, a PDA, and a laptop which are capable of running a program may be used as a print control device.

In FIG. 1, various image forming apparatuses such as a local printer 200-l which is locally connected, a laser multifunctional printer 200-1, a laser printer 200-2, an inkjet multifunctional printer 200-m, and an inkjet printer 200-n which is connected through the network 10 are illustrated. However, the type of an image forming apparatus is not limited to the image forming apparatuses illustrated in FIG. 1.

For instance, in a print system in FIG. 1, if a universal printer driver is installed in the print control device 100-1, a user may select a plurality of image forming apparatuses 200-1, 200-2, . . . , 200-m, 200-n using the universal printer driver.

More specifically, if a user writes a document using an application like a word processing program, the user may select a print menu on the upper tab of the application window. If the print menu is selected, a universal printer driver is executed and accordingly, image forming apparatuses connected to a print control device are searched. The print control device generates and displays a list of searched image forming apparatus (referred to as the first list hereinbelow). The user may select a desired image forming apparatus from the displayed first list. If the user selects an image forming apparatus, a driver UI corresponding to the selected image forming apparatus is generated and displayed on a screen. The user may set various print options on the driver UI and input a print command.

In another example, a user may directly select and execute a universal printer driver program and then select a file to be printed from among pre-stored files. If the user selects a file, connected image forming apparatuses are searched and listed in the first list, and then the user may select an image forming apparatus from the first list.

Meanwhile, in the print control device 100-1, another list for an image forming apparatus (referred to as the second list hereinbelow) may be displayed along with a driver UI. The second list may be included in a driver UI, be displayed in a separate pop-up window, or be displayed in an application program execution window.

In the second list, only the name of an image forming apparatus may be listed, or information related to the image forming apparatus may also be listed. That is, information regarding the specification of the image forming apparatus or information regarding the setting of print options supported by the image forming apparatus may also be listed. In addition, the name of the image forming apparatus or related information listed in the second list may be the information already stored in the print control device 100-1 or may be newly searched information.

If a user cannot set a desired print option in the driver UI that he or she selected, or if the image forming apparatus selected by the user wants cannot be used due to various reasons such as power-off, jamming, and another printing operation, the user may select another image forming apparatus from the second list. That is, the user may display another driver UI using a currently displayed driver UI without closing the currently displayed driver UI. In this case, the currently displayed driver UI may be replaced with the new driver UI, or the new driver may be displayed in a separate window along with the currently displayed driver UI.

A user may set a print option using a new driver UI and proceed with a printing operation. If it is impossible to set a desired print option in the new driver UI or if it is impossible to perform printing, another image forming apparatus can be selected again directly from the second list and thus the driver UI can be changed.

If the image forming apparatus selected from the second list is turned off, or its network is disconnected, the print control device 100-1 may display an alert message indicating that the second image forming apparatus is unavailable instead of displaying a driver UI corresponding to the second image forming apparatus. Alternatively, the alert message may be displayed on the driver UI corresponding to the second image forming apparatus.

Not only the second list but also a current state of other image forming apparatus or an available option supported by the image forming apparatus may be displayed in the print control device 100-1. Such information may be displayed on the driver UI together with the second list, or may be displayed in a separate window. Accordingly, a user may check the options or current state of each image forming apparatus on a single screen without checking the driver UI of each image forming apparatus.

In the print system of FIG. 1, if a printing job is to be performed in another print control device 100-x, a local printer 200-l may be searched as an available image forming apparatus and be included in the first list.

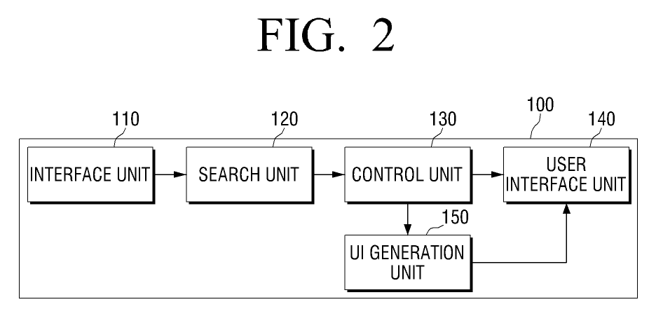

FIG. 2 is a block diagram illustrating the structure of a print control device according to an exemplary embodiment of the present general inventive concept. Referring to FIG. 2, the present print control device 100 comprises an interface unit 110, a search unit 120, a control unit 130, a user interface unit 140, and a UI generation unit 150.

The interface unit 110 is connected to more than one image forming apparatus directly or indirectly through a network or a local interface. The interface unit 110 may be connected to various kinds of image forming apparatuses through local, wired, or wireless network communication according to various communication standards. In other words, the interface unit 110 may include one or more physical ports, such as USB or other ports to communicate data. The interface unit 110 may include one or more wireless transceivers to communicate data wirelessly. The interface unit 110 may also include memory, processors, and supporting logic to control communication operations to and from the print control device 100.

The search unit 120 searches a connected image forming apparatus through the interface unit 110, and the search can be performed in various ways. For instance, the search unit 120 may transmit a query message periodically through the interface unit 110. The query message may be multi-cast or broadcast on a network. Accordingly, if an acknowledge message is received within a predetermined time, a user can recognize that the image forming apparatus which received the acknowledge message is currently connected to the network.

In addition, the search unit 120 may perform searching by identifying the IP address of a printer which has been registered as an available printer in a print control device or the IP address of a previously connected printer. The search unit 120 may include a software program stored in memory and executed by a processor to perform the search operation via the interface unit 110. The processor may be located in the control unit 130, or the search unit 120 may include a dedicated processor, memory, and/or logic circuitry.

The control unit 130 organizes the search results of the search unit 120 in a list, that is, the first list and displays it through the user interface unit 140. Searching for an image forming apparatus and organizing the first list may be performed by a universal printer driver program, but may also be performed by a separate application program or an individual print driver program. The control unit 130 includes one or more processors, memory, and/or supporting logic to execute operations to control the print control device 100. The control unit 130 may include a software program stored in memory and executed by a processor to perform the control operations.

The user interface unit 140 comprises an input means through which a user inputs a selection signal and an output means through which a predetermined message is indicated to the user. Specifically, the user interface unit may include various input means such as a mouse and keyboard, and output means such as a monitor and a speaker, or a display panel realized as a touch screen.

The user may select an image forming apparatus from the displayed first list through the user interface unit 140. The image forming apparatus selected from the first list will be referred to as the first image forming apparatus for convenience of explanation.

The control unit 130 controls the UI generation unit 150 to generate a driver UI for the selected first image forming apparatus.

The UI generation unit 150 generates a driver UI for the first image forming apparatus using pre-stored driver source and provides it to the user interface unit 140 in order to display it. The driver UI for the first image forming apparatus will be referred to as the first driver UI for convenience of explanation. The UI generation unit 150 may include a software program stored in memory and executed by a processor to perform the UI generation operation. The processor may be located in the control unit 130, or the UI generation unit 150 may include a dedicated processor, memory, and/or logic circuitry.

Along with the first driver UI, a list for at least one image forming apparatus, that is, the second list may be displayed in the user interface unit 140. The second list may include only information regarding image forming apparatuses except for the first image forming apparatus, or it may include all information including information regarding the first image forming apparatus.

A user or a manager may cause a driver UI for a selected image forming apparatus to be displayed by selecting one of the image forming apparatuses displayed in the second list without closing the currently displayed first driver UI. The image forming apparatus selected from the second list will be referred to as the second image forming apparatus, and the driver UI corresponding to the second image forming apparatus will be referred to as the second driver UI for convenience of explanation.

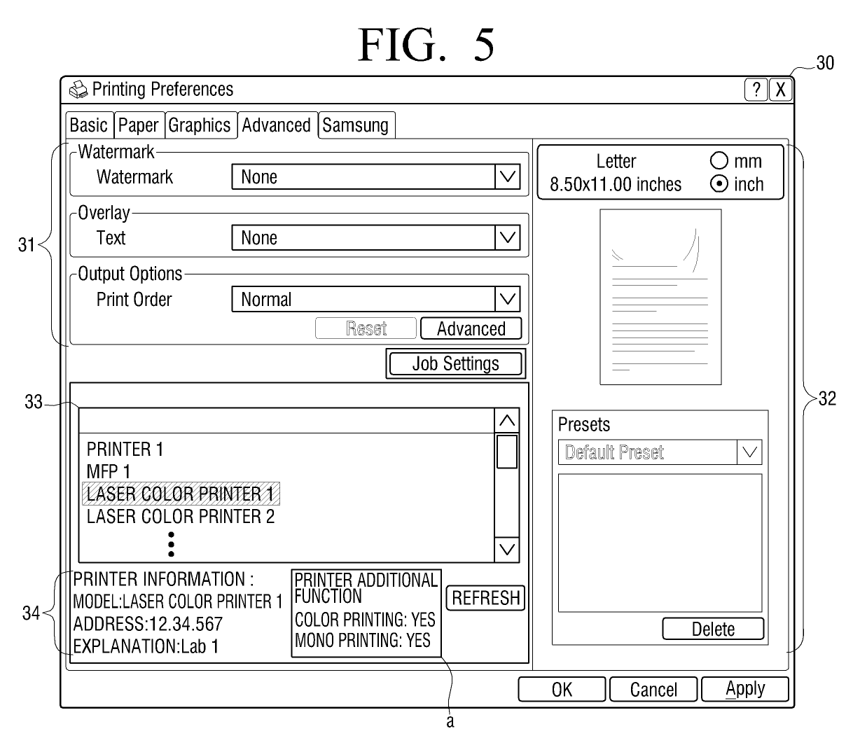

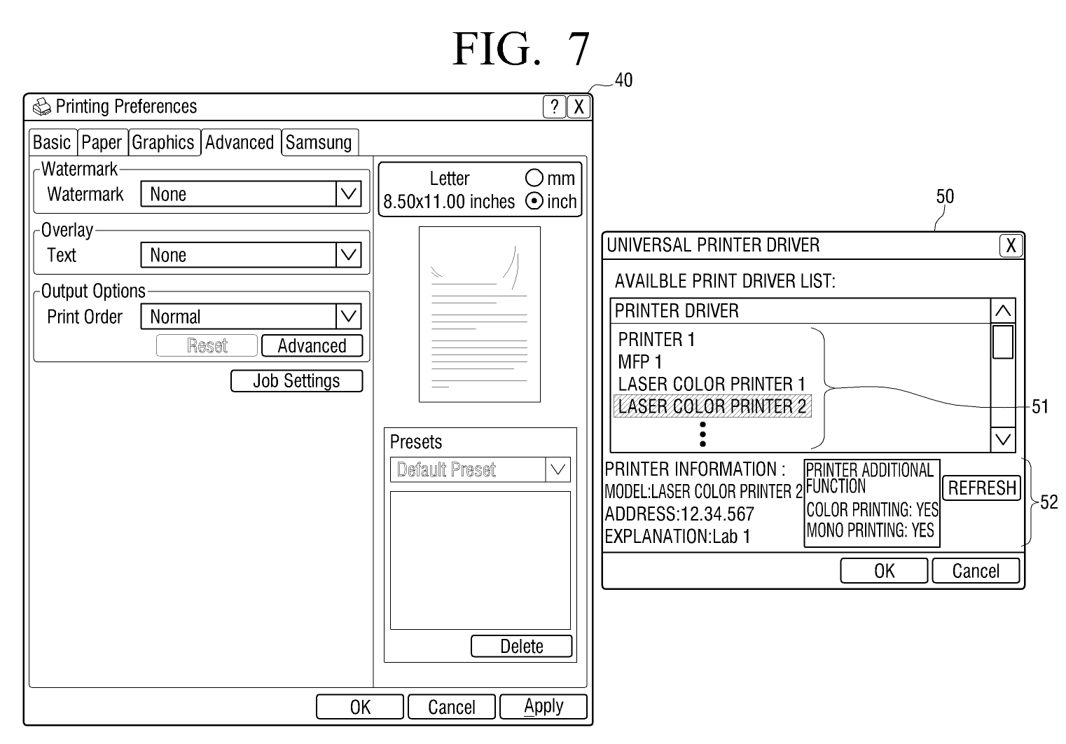

The second list may be displayed on the first driver UI, on a separate pop-up window, or on an application window depending on an exemplary embodiment of the present general inventive concept. This will be explained in detail with reference to FIG. 5 and FIG. 7.

If a user selects a print option on the second driver UI and inputs a print command, a document to be printed will be converted into a print data by a universal printer driver or an individual print driver of the print control device 100. That is, the print driver composes a print data in a format so that the print data can be interpreted in a language that a selected image forming apparatus uses. The conversion into a print data is a well-known function of a print driver, so detailed explanation will be omitted.

If the second image forming apparatus is selected from the second list, the control unit 130 may check the current state of the selected image forming apparatus. If the second image forming apparatus is currently connected or available, the second driver UI may be displayed, and if the second image forming apparatus is not connected or unavailable, an alert message indicating the current state of the second image forming apparatus may be displayed instead of the second driver UI. Alternatively, the second driver UI may be displayed along with the alert message on one portion of the second driver UI or on a separate pop-up window, leading the user to select another image forming apparatus instead of the second image forming apparatus.

If the second image forming apparatus is available and a print data is generated normally, the control unit 130 transmits the generated print data to the second image forming apparatus through the interface unit 110.

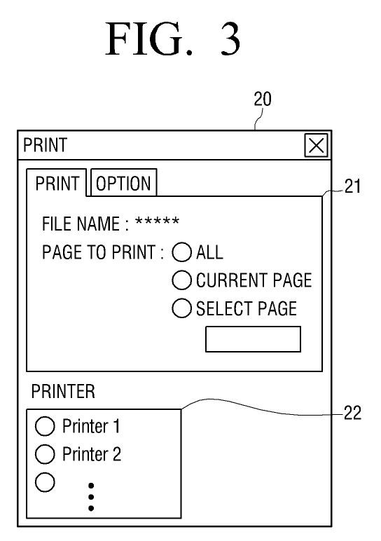

FIG. 3 is a view illustrating an example of a screen of a print control device according to an exemplary embodiment of the present general inventive concept. Referring to FIG. 3, if a print menu is selected from an application program, a window 20 including the first list 22 is displayed on the screen. The area 21 in which brief information regarding a document to be printed, the scope of printing, or the number of pages to be printed is determined may be displayed on the displayed window 20 along with the first list 22 indicating the search result of the image forming apparatus. As described above, the searching operation may represent an operation of broadcasting a query on an actual network, or an operation of reading out information regarding a pre-registered image forming apparatus from a storage unit (not shown) and including it in the first list.

As illustrated in FIG. 3, the apparatus names of a plurality of image forming apparatuses may be sequentially listed in the first list and available selection buttons may be placed at one side of each apparatus name, but this is only an example. The name of apparatuses and selectable buttons may be displayed in other ways.

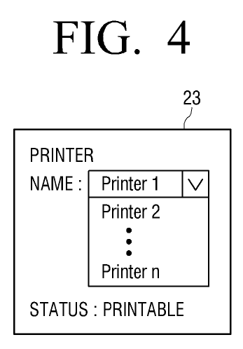

That is, the first list may be displayed as in FIG. 4. Referring to FIG. 4, only one display area and one selection button are displayed on the first list window 23. In the display area, the name of an image forming apparatus which is set as default is displayed for the first time. In this case, if a selection button is selected, a space for listing the names of various image forming apparatuses may be formed below the display area. A user may change the apparatus names displayed in the display area using various input means such as a mouse and a keyboard.

FIG. 3 and FIG. 4 illustrate various exemplary embodiments of how the first list is displayed, but the first list may be displayed in other ways.

If the first image forming apparatus is selected from the first list, the first driver UI corresponding to the selected first image forming apparatus is displayed.

FIG. 5 illustrates an example of configuration of the first driver UI. Referring to FIG. 5, the first driver UI 30 comprises an option setting area 31 to set various print options, a preview area 32 to display a preview of set options, the second list 33, an information area 34 to display information regarding the image forming apparatus displayed in the second list 33.

The disposition and location of each area in FIG. 5 are only examples, and each area may be disposed and located in various ways. At least one of each area may be omitted, or another area which has not been displayed may be added.

The names of various print drivers or image forming apparatuses are displayed in the second list 33 of FIG. 5. A user may select an image forming apparatus by moving a cursor on the second list 33.

Various information regarding the image forming apparatus or the print driver on which the cursor is placed is displayed in the information area 34. For instance, not only information (a) regarding the name and address of a printer model, and additional functions supported by the printer but also information regarding the current state of the printer may be displayed as illustrated in FIG. 5. That is, information regarding whether the printer is currently off or not, whether a printing job is being performed, how many printing jobs are to be performed, or whether the printer is jammed or out of order may also be displayed in the information area 34.

The information displayed in the information area 34 may be changed depending on the movement of the cursor on the second list 33.

That is, if the cursor is placed on “laser color printer 1” on the second list 33 of FIG. 5, the information (a) that the laser color printer 1 supports color printing and mono-printing may be displayed in the information area 34.

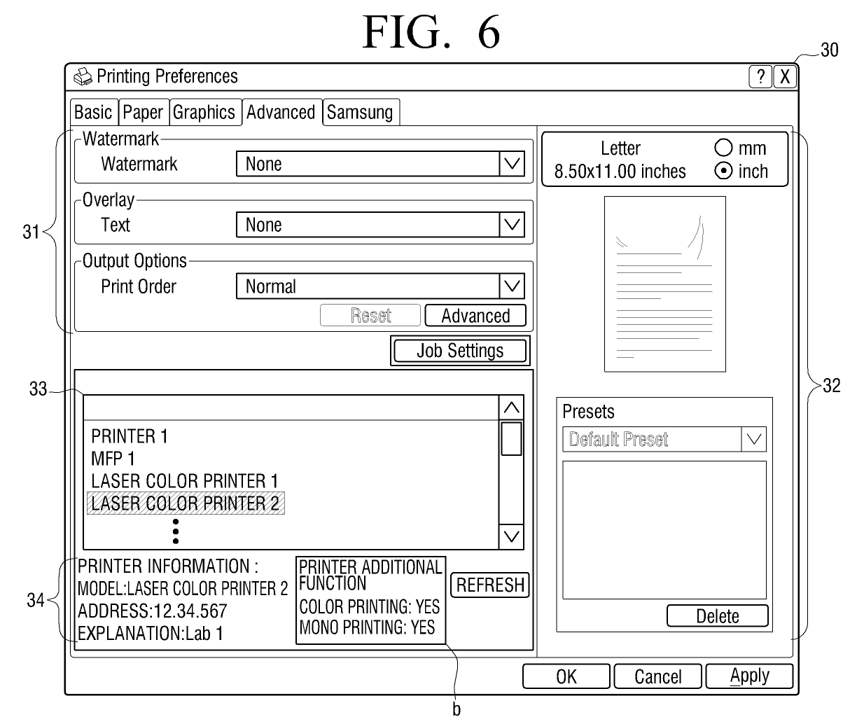

In this case, if the cursor moves to “laser color printer 2” on the second list 33 as illustrated in FIG. 6, the information displayed in the information area 34 is changed, and the information regarding the functions supported by the printer is also changed. That is, the information (b) that the laser color printer 2 supports not only color printing, mono-printing but also double-sided printing may be displayed.

Accordingly, a user may check whether desired functions are supported or not conveniently without opening driver UIs of each printer.

FIG. 7 is a view illustrating an example of screen configuration according to another exemplary embodiment of the present general inventive concept. In FIG. 7, the second list 51 is displayed on a new window 50 which is separate from the first driver UI 40. The new window 50 may be realized as a pop-up window which is displayed in a certain part of the screen for a predetermined time or may be realized as an application window. The second list 51 may be displayed in one portion of the new window 50 in which an area 52 to display information regarding each image forming apparatus included in the second list 51 may be formed.

If a second image forming apparatus is selected from the second list displayed in FIG. 5 to FIG. 7, the first driver UI is immediately changed to a new driver UI corresponding to the second image forming apparatus. That is, various menu areas to set various print options supported by the second image forming apparatus are newly displayed, and the menu areas which are not supported by the second image forming apparatus are deleted. The second driver UI may be displayed by replacing the first driver UI, but may be additionally displayed while the first driver UI is still displayed.

As described above, a driver UI and a list may be generated and displayed in various ways.

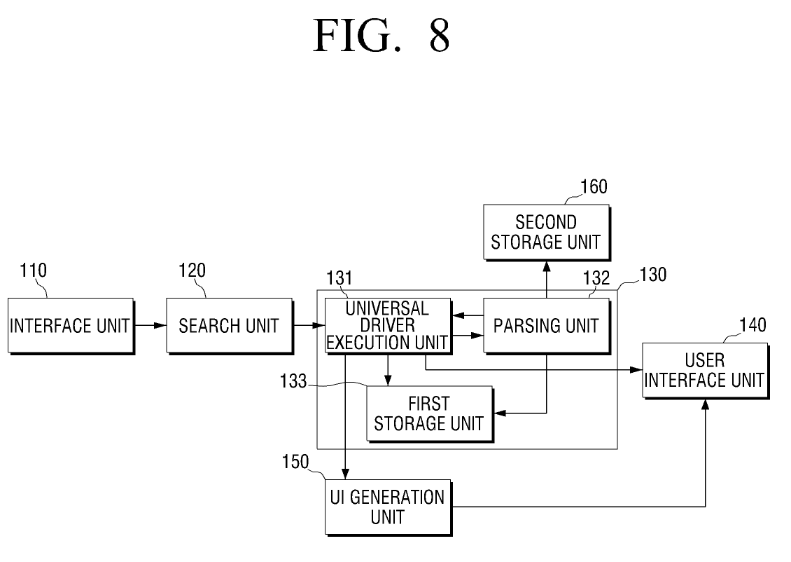

FIG. 8 is a block diagram illustrating the detailed structure of a print control device according to another exemplary embodiment of the present general inventive concept.

Referring to FIG. 8, a print control device comprises the interface unit 110, the search unit 120, the control unit 130, the user interface unit 140, the UI generation unit 150 and the second storage unit 160, and the control unit 130 may comprise a universal driver execution unit 131, a parsing unit 132, and a first storage unit 133.

The interface unit 110, the search unit 120, the UI generation unit 150, and the user interface unit 140 have already been explained with reference to FIG. 1, so the detailed explanation regarding these will be omitted.

The first storage unit 133 in FIG. 8 may be a main memory storing software such as a universal printer driver. In FIG. 8, the first storage unit 133 is formed in the control unit 130 but this is only an example.

Accordingly, the control unit 130 may control overall operation of an image forming apparatus by executing a universal printer driver stored in the first storage unit 133. Specifically, the control unit 130 executes a universal printer driver by controlling the search unit 120, the UI generation unit 150 and the like to generate the first or the second driver UI, and if a print command is input ultimately, the control unit 130 may even perform the operation of converting print data and transmitting it.

The universal driver execution unit 133 in the control unit 130 may execute a universal printer driver. The universal driver execution unit 133 may be realized as a central processing unit (CPU).

The universal driver execution unit 133 executes a universal printer driver stored in the first storage unit 133 and controls the UI generation unit 150 to generate a driver UI.

In this case, the universal driver execution unit 133 may generate the driver UI using driver UI resources stored in the first storage unit 133, the second storage unit 160 or a separate storage unit (not shown).

The parsing unit 132 parses feature configuration tables for each printer model stored in the first storage unit 133, the second storage unit 160 or a separate storage unit (not shown) and provides information regarding print options supported by a selected image forming apparatus and information regarding the printer to the universal driver execution unit 133.

In addition, the parsing unit 132 may parse the search result of the search unit 120 and provide it to the universal driver execution unit 133. The universal driver execution unit 133 may compose the first list according to the parsed search result.

The second storage unit 160 may store historical information regarding apparatuses selected from various lists such as the first image forming apparatus and the second image forming apparatus.

The control unit 130 may change the format of displaying a driver UI or a list depending on the historical information stored in the second storage unit 160. That is, if an image forming apparatus has been selected previously, the image forming apparatus is displayed differently from other image forming apparatus on the driver UI or on the list.

Specifically, the apparatus name of the image forming apparatus may be displayed in a larger font or in a different color. Alternatively, the apparatus name may be displayed distinctively by applying special effect such as adding shading or changing character type, or the number of selections according to historical information may be added to one side of the apparatus name.

The driver UI of an image forming apparatus which has been previously selected may be composed distinctively. That is, historical information may be displayed together in the driver UI, or display type, location, or color of the driver UI may be changed.

Accordingly, a user may identify a previously selected image forming apparatus easily.

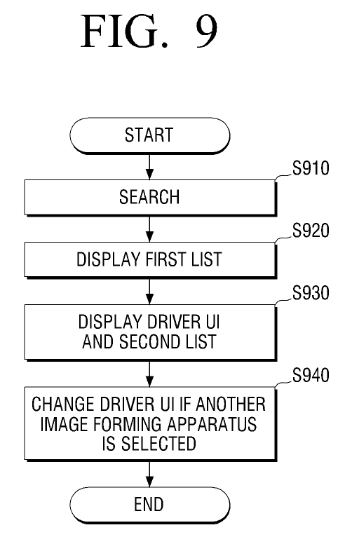

FIG. 9 is a flow chart provided to explain a method to control a print control device according to an exemplary embodiment of the present general inventive concept.

According to FIG. 9, a print control device in which a universal printer driver is installed searches for a connectable or registered image forming apparatus (S910). Accordingly, a list of searched image forming apparatuses is organized and displayed as the first list (S920). An example of configuration of the first list has been illustrated and described with reference to FIG. 2 and FIG. 3, so the detailed explanation regarding it will be omitted.

A user may select a desired image forming apparatus from the first list. Accordingly, if an image forming apparatus is selected, a driver UI corresponding to the selected image forming apparatus, that is, the first driver UI is displayed (S930).

In this case, the second list is also displayed in the first driver UI or in a separate window. The second list represents a list in which image forming apparatuses are arranged and the image forming apparatuses selected from the first list may be included in the second list. Various methods to display the first driver UI and the second list have been explained with reference to FIG. 4 to FIG. 7, so detailed explanation regarding these will be omitted.

In this case, a user may select the second image forming apparatus from the second list without closing the first driver UI, that is, while the first driver UI is being displayed. If the second image forming apparatus is selected, the second driver UI corresponding to the second image forming apparatus is newly generated (S940).

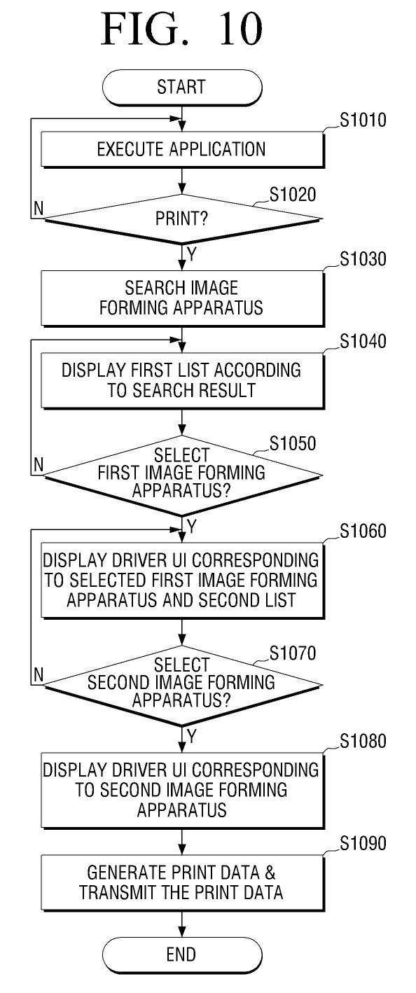

FIG. 10 is a flow chart provided to explain a method to control a print control device in detail according to an exemplary embodiment of the present general inventive concept.

According to FIG. 10, a user may execute an application (S1010) to select a print menu (S1020).

If a print menu is selected, a print control device searches all the connected image forming apparatuses (S1030). As described above, the print control device may directly search an image forming apparatus by querying a connected image forming apparatus locally or via network, or search an image forming apparatus by detecting information regarding an image forming apparatus pre-registered by a user or an administrator from a storage unit.

If the searching operation is completed, the first list is displayed according to the search result (S1040), and a user may select the first image forming apparatus from the first list.

If the first image forming apparatus is selected (S1050), the print control device displays the first driver UI corresponding to the selected first image forming apparatus and the second list (S1060). The first driver UI and the second list are displayed as described above.

A user may select the second image forming apparatus from the second list (S1070). That is, if a desired print option is not supported by the currently displayed first driver UI, or it is determined that the first image forming apparatus cannot perform printing or is not connectable, the user may select the second image forming apparatus. If the first image forming apparatus is not usable when the user inputs a print command in the first driver UI, an alert message informing this may be provided.

If the second image forming apparatus is selected, the second driver UI corresponding to the second image forming apparatus is displayed (S1080).

Accordingly, a universal printer driver generates print data according to the print option set in the second driver UI and transmits the generated print data to the second image forming apparatus (S1090).

Although not illustrated in FIG. 9 and FIG. 10, the operation of storing information regarding the first list which has been created by searching operation may be further included, and the stored information may be used in composing the first list, the second list.

If the second image forming apparatus is selected and the second image forming apparatus is not usable, an alert message may be displayed again. Accordingly, a user may select the third or the fourth image forming apparatus from the second list without closing the second driver UI, and may input a print option setting and a command in a new driver UI corresponding to the selected image forming apparatus.

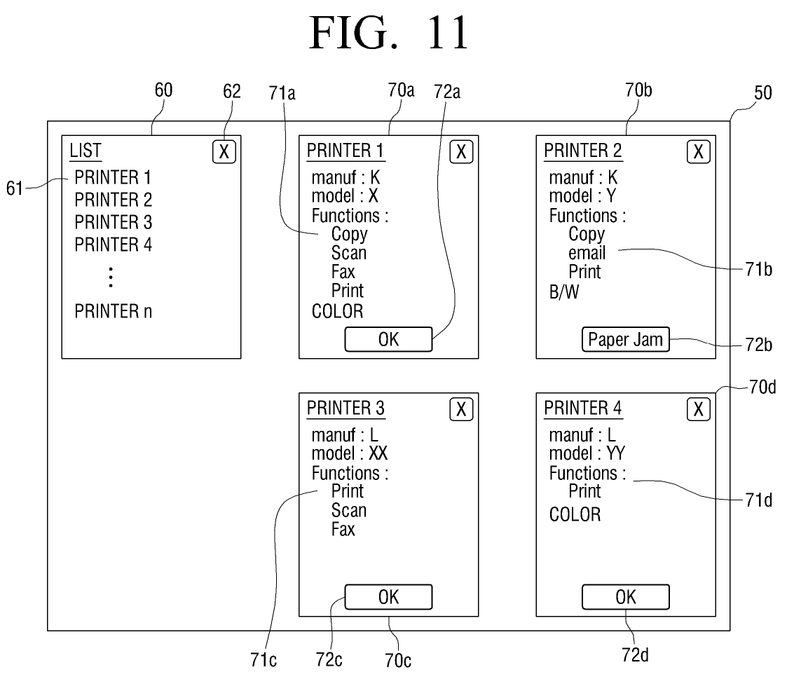

FIG. 11 illustrates a user interface according to an embodiment of the present general inventive concept that may be generated in conjunction with the print control device 100 of FIG. 2, for example. Upon receiving a print command or input, or upon receiving any other command to form an image of a document, photo, or file, the control unit 130 may generate a list 60 on a screen 50. The list 60 may include all printers configured to be used with the print control device 100. The list 60 may also include only the printers or image-forming apparatuses that are presently connected to the print control device 100. For example, the search unit 120 may query the image-forming apparatuses 200-1 . . . 200-n to determine which of the configured image forming apparatuses is presently connected to the print control device 100.

The search unit 120 may also determine with image-forming apparatuses are functional, turned on, or appropriate to the requested image-forming operation. For example, if a fax operation is initiated, the search unit 120 may query the connected image-forming apparatuses to determine which image-forming apparatuses are capable of performing a fax operation, and the list 60 may include only those image-forming apparatuses. Alternatively, the list 60 may include every configured, connected, or operation image-forming apparatus.

The graphical user interface (GUI) representation of the list 60 may include an icon 62 to close the list 60. A user may select one or more image-forming apparatuses 61 displayed on the list. When the user selects the image-forming apparatus 61, the UI generation unit 150 may generate a new window, tab, or area 70a, 70b, 70c, and 70d corresponding to each selected image-forming apparatus to display information about the respective image-forming apparatus. The new window, tab, or area may be launched by a driver specific to the particular image-forming apparatus, or it may be launched by a universal image-forming apparatus driver capable of controlling a plurality of different types of image-forming apparatuses.

For example, in FIG. 11, if a user selects printers 1, 2, 3, and 4, the control unit 130 may launch a universal driver or four separate drivers corresponding to the four printers to cause the UI generation unit 150 to generate four different windows, tabs, or areas 70a, 70b, 70c, and 70d corresponding to the four selected printers. The image-forming apparatuses may be of different manufacturers, models, or functions. The windows 70a, 70b, 70c, and 70d may display any information corresponding to the respective image-forming apparatuses including manufacture, model, functions, color type, network address, web-page of manufacturer, or other information.

The windows 70a, 70b, 70c, and 70d may also display a status of the image-forming apparatus. For example, if the search unit 120 determines that the printer2 has a paper jam, a notice of the paper jam may be displayed in the window 70b corresponding to the printer2. If an image-forming apparatus is operational, the window may display that the image-forming apparatus is “OK,” or some other indication that the image-forming apparatus is operational. As illustrated in FIG. 11, the indication of the status of the image-forming apparatus may also serve as a selectable icon 72a, 72b, 72c, and 72d to configure the respective image-forming apparatus to perform an imaging operation. Alternatively, a user may select a different icon to perform an imaging operation. For example, each displayed function may serve as a selectable icon so that a user may select “fax” from one image-forming apparatus to perform a fax operation and “print” from another image-forming apparatus to perform a print operation.

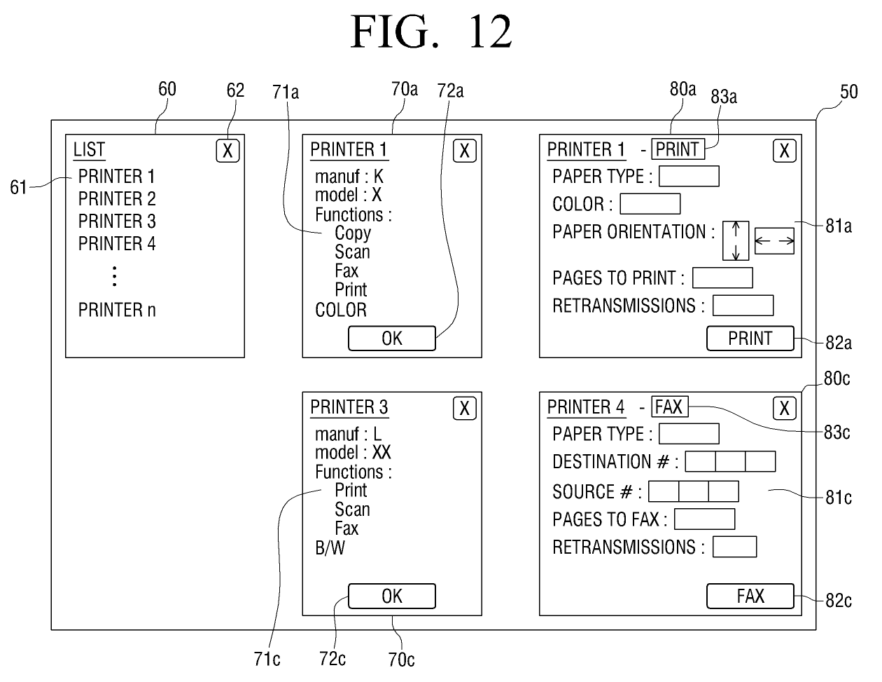

FIG. 12 illustrates a screen 50 including the list 60, windows 70a and 70b corresponding to two selected image-forming apparatuses, Printer1 and Printer3, and windows, tabs, or areas 80a and 80c to configure the respective image-forming apparatuses to perform an imaging operation. In other words, if a user selects the “OK” icons 72a and 72c corresponding to the image-forming apparatuses Printer1 and Printer3, respectively, the control unit 130 may execute a universal driver or two separate drivers corresponding to the respective image-forming apparatuses to cause the UI generation unit 150 to generate the windows, tabs, or areas 80a and 80c. The configuration windows 80a and 80c may be displayed simultaneously.

The configuration windows 80a and 80c may include a plurality of functions and settings 81a and 81c, respectively, adjustable by a user prior to performing an imaging operation. The configuration windows 80a and 80c may include imaging operation icons 83a and 83c to allow a user to select an imaging operation to be performed by the respective image-forming apparatus. The configuration windows 80a and 80c may also include other data, such as toner data, power data, paper data, or any other data about the respective image-forming apparatuses. The configuration windows 80a and 80c may include action icons 82a and 82c selectable by a user to execute a desired imaging operation.

As illustrated in FIGS. 11 and 12, any portion of the image-forming process may be performed by a universal image-forming apparatus driver. For example, only generating the list 60 may be performed by the universal driver, and the subsequent windows 70 and 80 may be generated by drivers specific to the respective image-forming apparatuses. Alternatively, the list 60 and windows 70 may be generated by the universal image-forming apparatus driver, and the configuration windows 80 may be generated by drivers specific to the respective selected image-forming apparatuses. Alternatively, all of the windows 60, 70, and 80 may be generated by the universal image-forming apparatus driver.

The present print control device may be realized as various kinds of electronic devices as described above. In addition, the print control device may be referred to as a host PC, a master device, and the like. The present specification describes the case in which a universal printer driver is used, but the same technical feature of the present general inventive concept may be applied when a universal scanner driver is used. That is, if a user wishes to change the UI of a scanner in a control device connected to a plurality of scanners, a new UI may be displayed while the previous UI is still maintained.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of controlling a print control device having a universal printer driver capable of controlling a plurality of image forming apparatuses, the method comprising:
searching the plurality of image forming apparatuses to print a document to be printed;
displaying a first list including at least one image forming apparatus according to the search result;
if a first image forming apparatus is selected from the first list, displaying a driver user interface (UI) corresponding to the selected first image forming apparatus;
displaying a second list including at least one image forming apparatus while the driver UI is maintained; and
if a second image forming apparatus is selected from the second list, displaying a driver UI corresponding to the selected second image forming apparatus.

2. The method of claim 1, further comprising:
generating a print data for a document to be printed using a driver UI of the second image forming apparatus and transmitting the generated print data to the second image forming apparatus.

3. The method of claim 1, wherein the second list includes a first image forming apparatus corresponding to a currently displayed driver UI.

4. The method of claim 1, wherein displaying the second list includes generating the second list according to at least one of pre-stored information in the print control device and search result information of newly connected image forming apparatus.

5. The method of claim 1, further comprising:
if the second image forming apparatus is selected from the second list, confirming whether the selected second image forming apparatus is currently operated.

6. The method of claim 1, wherein the second list is selected by a user or an administrator.

7. The method of claim 1, wherein the second list is included in the driver UI or is displayed in a separate pop-up window.

8. The method of claim 1, wherein the second list displays at least one of information regarding at least one image forming apparatus and its setting information.

9. The method of claim 1, further comprising:
storing at least one of information regarding a first image forming apparatus selected from the first list and a second image forming apparatus selected from the second list as historical information.

10. The method of claim 9, wherein displaying the second list includes displaying an image forming apparatus included in the stored historical information distinctively from other image forming apparatuses in the second list, or in a separate application UI.

11. The method of claim 1, further comprising:
storing the first list.

12. A print control device having a universal printer driver to control a plurality of image forming apparatuses, comprising:
an interface unit connectable to a plurality of image forming apparatuses, each image forming apparatus having a separate driver;
a search unit to search the plurality of image forming apparatuses;
a user interface unit to display a first list including a first image forming apparatus of the searched image forming apparatuses;
a UI generation unit to generate a driver UI corresponding to the first image forming apparatus when the first image forming apparatus is selected from the first list, and to display the driver UI via the user interface unit; and
a control unit to display a second list including at least one second image forming apparatus while the driver UI is displayed and, if the second image forming apparatus is selected from the second list, to control the UI generation unit to generate a driver UI corresponding to the selected second image forming apparatus.

13. The print control device of claim 12, further comprising:
a first storage unit to store the universal printer driver,
wherein the control unit drives the search unit and the UI generation unit by executing the universal printer driver, generates a print data for a document to be printed using a driver UI of the second image forming apparatus, and transmits the generated print data to the second image forming apparatus.

14. The print control device of claim 12, wherein the control unit identifies a current state of the selected second image forming apparatus and displays a driver UI or an alert message corresponding to the second image forming apparatus according to the identified information if the second image forming apparatus is selected from the second list.

15. The print control device of claim 12, wherein the second list is included in the driver UI or is displayed in a separate pop-up window.

16. The print control device of claim 12, wherein the second list displays information regarding at least one image forming apparatus and its setting.

17. The print control device of claim 12, further comprising:
a second storage unit to store at least one of information regarding a first image forming apparatus selected from the fist list and a second image forming apparatus selected from the second list as historical information.

18. The print control device of claim 17, wherein the control unit controls the user interface unit to display an image forming apparatus included in the stored historical information distinctively from other image forming apparatuses in the second list, or in a separate application UI.

19. A computer-readable medium having stored thereon a first universal image-forming apparatus driver to control an image-forming apparatus control device to perform a method, the method comprising:
displaying a user interface including a plurality of image-forming apparatuses connected to the image-forming apparatus control device, each displayed image-forming apparatus corresponding to a separate second driver to control in image-forming operation of the respective image-forming apparatus; and
performing an image-forming operation on at least one of the plurality of image-forming apparatuses using the first universal image-forming apparatus driver.
